(19) United States
(12) Patent Application Publication
(10) Pub. No.: US 2022/0029156 A1
(43) Pub. Date: Jan. 27, 2022

(54) COBALT-FREE LITHIATED SPINEL CATHODE MATERIALS FOR USE IN LITHIUM CELLS AND BATTERIES

(71) Applicant: UCHICAGO ARGONNE, LLC, Chicago, IL (US)

(72) Inventors: Michael M. THACKERAY, Naperville, IL (US); Eungje LEE, Naperville, IL (US); Jason R, CROY, Plainfield, IL (US); Boyu SHI, Willowbrook, IL (US); Jihyeon GIM, Naperville, IL (US)

(73) Assignee: UCHICAGO ARGONNE, LLC, Chicago, IL (US)

(21) Appl. No.: 17/136,234

(22) Filed: Dec. 29, 2020

Related U.S. Application Data
(60) Provisional application No. 63/055,993, filed on Jul. 24, 2020.

(51) Int. Cl. H01M 4/525; H01M 4/505; H01M 4/58; H01M 4/66; H01M 10/0525; H01M 4/36; H01M 4/62

(52) U.S. Cl. CPC H01M 4/525; H01M 4/505; H01M 4/58; H01M 4/623; H01M 10/0525; H01M 4/366; H01M 4/663

(57) ABSTRACT

Cobalt-free lithium-manganese-nickel-oxide electrode materials for lithium cells and batteries, notably rechargeable Li-ion batteries, are described herein. These electrode materials have a lithiated-spinel structure with the general formula LiMnₓNi_{y}M_{z}O₂, or alternatively in lithiated-spinel notation, Li₂Mn₂ₓNi_{2y}M_{2z}O₄, in which x+y+z=1, 0<x<1.0, 0<y<1.0, 0≤z≤0.5, and in which M is selected from one or more metal cations other than Mn, Ni and Co. In general, the Mn:Ni ratio in the lithiated-spinel structures described herein is less than 2:1 and greater than 1:2, preferably close to 1:1, and more preferably 1:1. Optionally, the cobalt-free lithiated spinel materials can be blended or structurally-integrated with other cathode materials that may include cobalt.

### CROSS-REFERENCE TO RELATED APPLICATIONS

This application claims the benefit of U.S. Provisional Application Ser. No. 63/055,993, filed on Jul. 24, 2020, which is incorporated herein by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to electrode materials useful for rechargeable lithium-based cells and battery systems.

### BACKGROUND

Today, rechargeable lithium-ion batteries (LIBs) command a multi-billion-dollar industry. LIBs operate by shuttling lithium ions between the negative electrode (the anode) and the positive electrode (the cathode) during discharge and charge. Well-known examples of anode materials are carbon, particularly graphite, and the lithium-titanate spinel, Li₄Ti₅O₁₂ (LTO). Well-known cathode products include materials with layered structures, compositional variations of the lithium-manganese-oxide spinel, and lithium-iron-phosphate, LiFePO₄ (LFP), which has an olivine-type structure. Examples of layered materials include LiCoO₂ (LCO), LiNi_{0.8}Co_{0.15}Al_{0.05}O₂ (NCA) and various lithium-nickel-manganese-oxide (NMC) compositions such as LiNi_{0.6}Co_{0.2}Mn_{0.2}O₂ (NMC622), LiNi_{0.33}Co_{0.33}Mn_{0.33}O₂ (NMC111), and lithium-rich variants, L₁₊ₓM₁₋ₓO₂ (M=Ni,Mn,Co), alternatively designated in composite notation as wLi₂MnO₃.(1−w)LiMO₂. Examples of lithium-manganese-oxide spinel-type materials include LiMn₂O₄ (LMO), and the lithium-rich spinel Li_{1.03}Mn_{1.97}O₄. These materials represent electrodes, i.e., both anodes and cathodes, in their stable discharged state, thereby enabling the safe assembly of lithium-ion cells and batteries, as well as the safe transport of these products from manufacturer to customer across the globe.

Gummow et al. reported the discovery of a new polymorphic form of lithium-cobalt-oxide (LiCoO₂) in the Materials Research Bulletin, Volume 27, pages 327-337 (1992). This compound was designated LT-LiCoO₂ because it was synthesized at a relatively low temperature (LT) of 400° C., compared to the previously known layered LiCoO₂, which is prepared at a significantly higher temperature (HT), typically 900° C., i.e., HT-LiCoO₂. Gummow et al. also reported in Solid State Ionics, Volume 53-56, pages 681-687 (1992) that nickel could be substituted for cobalt in the LT-LiCo₁₋ₓNiₓO₂ system over the range (0<x≤0.2). From an X-ray structural analysis, it was concluded by Rossen et al. in Solid State Ionics, Volume 62, pages 53-60 (1993) that LT-LiCoO₂ had a lithiated-spinel structure, while the refinements of Gummow et al. in the Materials Research Bulletin, Volume 28, pages 235-246 (1993) suggested that LT-LiCoO₂ samples had a predominant lithiated-spinel-like structure that deviated from the ideal spinel arrangement of cations.

More recently, Lee et al. in ACS Applied Energy Materials, Volume 2, pages 6170-6175 (2019) revealed that Al-substitution for cobalt is also possible in LT-LiCo₁₋ₓAlₓO₂ for (0<x<0.5) but, in this case, the electrochemical signature differs from that provided by LT-LiCoO₂ and LT-LiCo₁₋ₓNiₓO₂ lithiated-spinel electrodes, exhibiting single-phase behavior on lithium extraction, rather than the typical two-phase behavior expected of spinel electrodes. A structural refinement of LT-LiCo_{0.85}Al_{0.15}O₂ (x=0.15) by Lee et al. indicated that this behavior could be attributed to a small amount of cation disorder on the octahedral sites of the lithiated-spinel LT-LiCo₁₋ₓAlₓO₂ structure. Consequently, these slightly disordered lithiated-spinel LT-LiCo₁₋ₓAlₓO₂ materials can be defined as having slightly disordered rock salt structures. Like layered LiCoO₂, LT-LiCoO₂ and substituted derivatives are discharged cathodes. Lithium-ion cells with these cathode materials coupled to graphite (carbon) anodes can therefore be assembled safely in the discharged state, i.e., when all the lithium required for the electrochemical reaction is contained in the cathode. Such cells provide an attractive operating cell voltage of approximately 3.5 V.

Cobalt-containing lithiated-spinel electrode materials, for example, LiCo₁₋ₓMₓO₂, in which M is one or more metal ions, such as Ni and/or Al, are also of interest as stabilizers for layered lithium-rich and manganese-rich wLi₂MnO₃.(1−w)LiMO₂(M=Ni, Mn, and Co; i.e., NMC) electrodes, as described by Lee et al. in Applied Materials & Interfaces, Volume 8, pages 27720-27729 (2016). An advantage of these electrodes is that both lithiated-spinel and layered wLi₂MnO₃.(1−w)LiMO₂ components have a rock salt composition, in which the number of cations equals the number of anions, thereby facilitating their structural integration, particularly when the two components have closely-matched crystallographic lattice parameters. Furthermore, the discovery of LT-LiCo₁₋ₓAlₓO₂ electrode materials has heightened interest in developing all-solid-state ‘spinel-spinel’ cells, which can be assembled in their discharged state, for example, by coupling a Li₄Ti₅O₁₂ spinel anode to a lithiated-spinel LT-LiCo₁₋ₓAlₓO₂ cathode with an appropriate lithium-ion conducting solid electrolyte, such as a solid inorganic electrolyte or a solid polymer electrolyte.

The generic family of materials with a spinel-type structure is broad and diverse. Numerous spinel-type compositions are found in nature while many others can be prepared synthetically in the laboratory, usually at elevated temperatures well above room temperature. The lithium spinels, such as LiMn₂O₄, Li₄Mn₅O₁₂, LiMn_{1.5}Ni_{0.5}O₄, and Li₄Ti₅O₁₂, which are of interest as electrodes for Li-ion battery applications, are typically prepared at temperatures between 400 and 900° C. By contrast, lithiation of the above-mentioned spinels to form lithiated-spinel products has to be conducted at room temperature or at slightly higher temperatures, e.g., 50° C., by chemical reactions, for example with butyl lithium, or by electrochemical reactions in an inert atmosphere because these lithiated-spinel structures are unstable at higher temperatures, particularly if heated in air or oxygen. In this respect, the family of lithiated cobalt-containing spinels, LiCo₁₋ₓMₓO₂, is distinct because they can be prepared at a moderately high temperature (for example, 400-500° C.) in air or oxygen, thereby offering the possibility of incorporating them as stabilizing components during the preparation of ‘layered-layered’ wLi₂MnO₃.(1−w)LiMO₂(M=NMC) electrode materials.

Of the cathode materials discussed above, LCO, NCA and NMC materials dominate the current global cathode materials market. All of these cathode materials contain cobalt, which is the most expensive and least abundant cathode component used in lithium-ion batteries. Major international efforts are therefore underway to find less expensive nickel-rich and manganese-rich alternatives that are cobalt-free, without compromising the electrochemical performance of lithium-ion cells. This has been a daunting task.

The materials, electrodes, cells and batteries described herein address the need for new cobalt-free, lithium-metal-oxide electrode structures and compositions.

### SUMMARY

Currently, there is great interest in developing cobalt-free oxides for lithium-ion cathodes. The cobalt-free cathode materials described herein have a lithiated-spinel-type structure. These novel materials open the door to the development and exploitation of lower cost and safer cobalt-free electrode materials for next generation lithium-ion cells and batteries. The cobalt-free lithiated spinel materials described herein have the general empirical formula LiMnₓNi_{y}M_{z}O₂, in which x+y+z=1, 0<x<1.0, 0<y<1.0, 0≤z≤0.5, or alternatively in lithiated-spinel notation, Li₂Mn₂ₓNi_{2y}M_{2z}O₄, and in which M is selected from one or more metal cations, excluding Mn, Ni and Co. Preferably, M comprises Mg, Al, Ga, a combination of Mg and Ti in a 1:1 ratio, or a combination thereof. In general, the Mn:Ni ratio in the lithiated-spinel structures described herein is less than 2:1 and greater than 1:2, preferably close to 1:1, and more preferably 1:1.

The following non-limiting embodiments of the materials and methods described herein are provided below to illustrate certain aspects and features of the compositions and methods described herein.

Embodiment 1 is a cobalt-free electrode active material for a lithium electrochemical cell a lithiated spinel structure having the empirical formula LiMnₓNi_{y}M_{z}O₂; wherein M comprises one or more metal cations other than manganese, nickel and cobalt, x+y+z=1, 0<x<1.0, 0<y<1.0, 0≤z≤0.5; and having a molar Mn:Ni ratio in the range of about 1:2 to about 2:1.

Embodiment 2 comprises the electrode active material of embodiment 1, wherein the Mn:Ni ratio is about or equal to 1:1.

Embodiment 3 comprises the electrode active material of embodiment 1 or embodiment 2, wherein M comprises one or more metal cation selected from the group consisting of an Al cation, a Ga cation, and a combination of Mg and Ti cations.

Embodiment 4 comprises the electrode active material of any one of embodiments 1 to 3, wherein at least two of the Li, Mn, Ni and M cations in the lithiated spinel are partially disordered over the octahedral sites of the lithiated-spinel structure.

Embodiment 5 is the electrode active material of any one of embodiments 1 to 4, wherein the lithiated-spinel structure contains cation and/or anion defects or deficiencies.

Embodiment 6 is the electrode active material of any one of embodiments 1 to 5, wherein the lithium, oxygen, and/or total non-lithium metal content of the lithiated-spinel composition LiMnₓNi_{y}M_{z}O₂ varies by up to about 5 percent from an ideal 1:1:2 respective elemental stoichiometry.

Embodiment 7 is the electrode active material of any one of embodiments 1 to 6, further comprising fluorine in place of a portion of the oxygen in the LiMnₓNi_{y}M_{z}O₂; wherein less than 10 mole percent of the oxygen is replaced by fluorine.

Embodiment 8 is an electrode active composition for an electrochemical cell comprising a first lithium-free electrode active material with a lithiated spinel structure mechanically blended with or structurally integrated with or a second electrode active material; wherein the first electrode active material has the empirical formula LiMnₓNi_{y}M_{z}O₂; wherein M comprises one or more metal cations other than manganese, nickel and cobalt; x+y+z=1; 0<x<1.0; 0<y<1.0; 0≤z≤0.5; and having a molar Mn:Ni ratio in the range of about 1:2 to about 2:1; and the second electrode active material comprises one or more cobalt-containing lithium metal oxide material.

Embodiment 9 comprises the electrode active material of embodiment 8, wherein the cobalt-containing lithium metal oxide material comprises LiCoO₂ with a layered-type structure and/or LiCoO₂ with a lithiated-spinel-type structure.

Embodiment 10 comprises the electrode active material of embodiment 8 or embodiment 9, wherein Co comprises less than about 33 mol % of non-lithium metal ions in the electrode active material.

Embodiment 11 comprises the electrode active material of any one of embodiments 8 to 10, wherein Co comprises less than 20 mol % of non-lithium metal ions in the electrode active material.

Embodiment 12 comprises the electrode active material of any one of embodiments 8 to 11, wherein Co comprises less than 10 mol % of the non-lithium metal ions.

Embodiment 13 comprises the electrode active material of any of embodiments 8 to 12, wherein the lithiated-spinel structure contains cation and/or anion defects or deficiencies.

Embodiment 14 is an electrode for a lithium electrochemical cell comprising particles of the electrode active material of any one of embodiments 1 to 13 in a binder matrix coated on a current collector.

Embodiment 15 comprises the electrode of embodiment 14, wherein the current collector comprises a metal or carbon material.

Embodiment 16 comprises the electrode of embodiment 15, wherein the current collector comprises a conductive carbon fiber paper.

Embodiment 17 comprises the electrode of embodiment 15, wherein the current collector comprises aluminum foil.

Embodiment 18 comprises the electrode of any one of embodiments 14 to 17, wherein the binder matrix comprises poly(vinylidene difluoride).

Embodiment 19 comprise the electrode of any one of embodiments 14 to 18, wherein the electrode further comprises particles of a conductive carbon material mixed with the electroactive material in the binder matrix.

Embodiment 20 is an electrochemical cell comprising an anode, a cathode, and a lithium-containing electrolyte contacting the anode and cathode, wherein the cathode comprises the electrode of any one of embodiments 14 to 19.

Embodiment 21 is a battery comprising a plurality of electrochemical cells of embodiment 20, electrically connected in series, in parallel, or in both series and parallel.

Embodiment 22 is a method for preparing the electrode active material of any one of embodiments 1 to 7, comprising heating a mixture of precursor salts at a temperature in the range of about 200 to about 600° C. in an oxygen-containing atmosphere (e.g., air); wherein the precursor salts comprises salts of Li, Mn, Ni and M cations with anions selected from the group consisting of carbonate, hydroxide, oxide, and nitrate; and the Li, Mn, Ni and M salts are present in a stoichiometric ratio selected to provide a target lithiated spinel of formula LiMnₓNi_{y}M_{z}O₂; wherein M comprises one or more metal cations other than manganese, nickel and cobalt, x+y+z=1, 0<x<1.0, 0<y<1.0, 0≤z≤0.5; and having a molar Mn:Ni ratio in the range of about 1:2 to about 2:1.

Embodiment 23 comprises the method of embodiment 22, wherein the mixture of precursor salts temperature is in the range of about 400 to 600° C.

Embodiment 24 comprises the method of embodiment 22 or embodiment 23, wherein the lithium salt is lithium carbonate, and the Ni, Mn, M salts are single or mixed metal hydroxides of Ni, Mn, and M metal cations.

Embodiment 25 comprises an electrode active material for a lithium electrochemical cell with a lithiated spinel structure having the empirical formula LiMnₓNi_{y}M_{z}O₂; wherein M comprises Co and, optionally, other metals besides manganese and nickel; x+y+z=1; 0<x<1.0; 0<y<1.0; 0≤z≤0.2; and having a molar Mn:Ni ratio in the range of about 1:2 to about 2:1.

Embodiment 26 comprises the electrode active material of embodiment 25, wherein 0≤z≤0.1.

Embodiment 27 comprises the electrode active material of embodiment 25 or 26, wherein at least two of the Li, Mn, Ni and M cations in the lithiated spinel are partially disordered over the octahedral sites of the lithiated-spinel structure.

Embodiment 28 is the electrode active material of any one of embodiments 25 to 27, wherein the lithiated-spinel structure contains cation and/or anion defects or deficiencies.

Embodiment 29 is the electrode active material of any one of embodiments 25 to 28, wherein the lithium, oxygen, and/or total non-lithium metal content of the lithiated-spinel composition LiMnₓNi_{y}M_{z}O₂ varies by up to about 5 percent from an ideal 1:1:2 respective elemental stoichiometry.

Embodiment 30 is the electrode active material of any one of embodiments 25 to 29, further comprising fluorine in place of a portion of the oxygen in the LiMnₓNi_{y}M_{z}O₂; wherein less than 10 mole percent of the oxygen is replaced by fluorine.

Embodiment 31 is the electrode active material of any one of embodiments 25 to 30 mechanically blended with or structurally integrated with another different electrode active material.

Embodiment 32 comprises an electrode active material comprising particles of the electrode active material of any one of embodiments 1 to 13 and 25 to 31 coated with a metal- oxide, a metal fluoride or a metal phosphate layer.

Embodiment 33 comprises the electrode active material of embodiment 32, wherein the metal oxide layer is a lithiated-spinel LiCo₁₋ₓAlₓO₂.

Embodiment 34 is an electrode active material comprising the electrode active material of any one of the embodiments 1 to 13 and 25-31 as a protective surface coating on an underlying lithium-metal-oxide electrode material.

Embodiment 35 comprises the lithium-metal-oxide electrode material of embodiment 34, wherein the underlying lithium-metal-oxide material has a layered or spinel structure.

Embodiment 36 is an electrode for a lithium electrochemical cell comprising particles of the electrode active material of any one of embodiments 25 to 35 in a binder matrix coated on a current collector.

Embodiment 37 comprises the electrode of embodiment 36, wherein the current collector comprises a metal or carbon material.

Embodiment 38 comprises the electrode of embodiment 37, wherein the current collector comprises a conductive carbon fiber paper.

Embodiment 39 comprises the electrode of embodiment 37, wherein the current collector comprises aluminum foil.

Embodiment 40 comprises the electrode of any one of embodiments 36 to 39, wherein the binder matrix comprises poly(vinylidene difluoride).

Embodiment 41 comprise the electrode of any one of embodiments 36 to 40, wherein the electrode further comprises particles of a conductive carbon material mixed with the electroactive material in the binder matrix.

Embodiment 42 is an electrochemical cell comprising an anode, a cathode, and a lithium-containing electrolyte contacting the anode and cathode, wherein the cathode comprises the electrode of any one of embodiments 36 to 41.

Embodiment 43 is a battery comprising a plurality of electrochemical cells of embodiment 42, electrically connected in series, in parallel, or in both series and parallel.

Embodiment 44 comprises a method for preparing the electrode active material of embodiment 25 to 29, comprising heating a mixture of precursor salts at a temperature in the range of about 200 to about 600° C. in an oxygen-containing atmosphere; wherein the precursor salts comprises salts of Li, Mn, Ni and M cations with anions selected from the group consisting of carbonate, hydroxide and nitrate, and the Li, Mn, Ni and M salts are present in a stoichiometric ratio selected to provide a target lithiated spinel of formula LiMnₓNi_{y}M_{z}O₂; wherein M comprises Co and, optionally, other metal cations besides manganese and nickel; x+y+z=1; 0<x<1.0; 0<y<1.0; 0≤z≤0.2; and having a molar Mn:Ni ratio in the range of about 1:2 to about 2:1.

### BRIEF DESCRIPTION OF THE DRAWINGS

FIG. 1 depicts the X-ray diffraction pattern of LT-LiMn_{0.5}Ni_{0.5}O₂.

FIG. 2 depicts the voltage (V) vs. specific capacity (mAh/g) plots of a Li/LT-LiMn_{0.5}Ni_{0.5}O₂ cell.

FIG. 3 depicts the voltage (V) vs. specific capacity (mAh/g) plots of a graphite/LT-LiMn_{0.5}Ni_{0.5}O₂ cell.

FIG. 4 depicts the X-ray diffraction pattern of LT-LiMn_{0.45}Ni_{0.45}Al_{0.1}O₂.

FIG. 5 depicts the initial voltage (V) vs. specific capacity (mAh/g) plot of a Li/ LT-LiMn_{0.45}Ni_{0.45}Al_{0.1}O₂ cell.

FIG. 6 depicts the specific capacity vs. cycle number plots of a Li/LT-LiMn_{0.45}Ni_{0.45}Al_{0.1}O₂ cell.

FIG. 7 depicts the X-ray diffraction pattern of a LT-LiMn_{0.5}Ni_{0.5}O₂+LT-LiCo_{0.75}Al_{0.25}O₂ electrode powder, blended in a 90:10 percent ratio, respectively.

FIG. 8 depicts the electrochemical profile of the initial discharge of a Li/LT-LiMn_{0.5}Ni_{0.5}O₂+LT-LiCo_{0.75}Al_{0.25}O₂ cell.

FIG. 9 depicts the specific capacity vs. cycle number plots of a Li/LT-LiMn_{0.5}Ni_{0.5}O₂ LT-LiCo_{0.75}Al_{0.25}O₂ cell.

FIG. 10 depicts the X-ray diffraction pattern of LT-LiMn_{0.475}Ni_{0.475}Co_{0.05}O₂.

FIG. 11 depicts the electrochemical profile of the initial discharge of a Li/LT-LiMn_{0.45}Ni_{0.45}Co_{0.1}O₂ cell.

FIG. 12 depicts the voltage (V) vs. specific capacity (mAh/g) plots of a Li/LT-LiMn_{0.475}Ni_{0.475}Co_{0.05}O₂ cell.

FIG. 13 depicts a schematic representation of an electrochemical cell.

FIG. 14 depicts a schematic representation of a battery consisting of a plurality of cells connected electrically in series and in parallel.

### DETAILED DESCRIPTION

Materials with a spinel-type structure, as epitomized by the prototypic mineral spinel, having the formula MgAl₂O₄, are abundant in nature and they are diverse in their composition. For the lithium battery industry, lithium-metal-oxide electrodes with a spinel-type structure, such as lithium titanate, Li₄Ti₅O₁₂ (Li[Li_{1/3}Ti_{5/3}]O₄), and lithium manganate LiMn₂O₄ and substituted derivatives thereof, e.g., Li[Mn_{2.δ}Li_{δ}]O₄, can be prepared by a variety of synthetic techniques at elevated temperatures. High-temperature synthesis is important and necessary for fabricating electrode particles with an acceptably high packing density. On the other hand, it is well-known that lithiated spinels, such as Li₇Ti₅O₁₂ (Li₂[Li_{1/3}Ti_{5/3}]O₄) and Li₂[Mn₂]O₄ can be prepared electrochemically at room temperature and slightly elevated temperature (e.g., 60° C.). However, when heated at elevated temperatures, particularly in air or oxygen, these lithiated spinel structures are unstable and tend to transform to other structure types. Indeed, only a few examples of lithiated spinels that can be prepared at an elevated temperature of about 400° C. are known to exist, notably those in the family of lithiated-cobalt-oxide spinels LiCo₁₋ₓMₓO₂, alternatively in spinel notation, Li₂Co₂₋₂ₓM₂ₓO₄ (e.g., where M=Ni, Al, Ga), as described by Gummow et al. and by Lee et al. in references already provided herein.

As described herein, Co-free, lithiated-spinel electrode materials are described herein, which have the formula LiMnₓNi_{y}M_{z}O₂, alternatively Li₂Mn₂ₓNi_{2y}M_{2z}O₄ in lithiated-spinel notation, in which x+y+z=1, 0<x<1.0, 0<y<1.0, 0≤z≤0.5, and M is a metal cation excluding Mn, Ni and Co. The reversible electrochemical capacity of these electrodes is generated predominantly from redox reactions that occur on the nickel ions, as it does in layered LiMn_{0.5}Ni_{0.5}O₂ and spinel LiMn_{1.5}Ni_{0.5}O₄ electrodes, while the tetravalent Mn ions operate predominantly as electrochemically-inactive spectator ions during charge and discharge of the cell. The strategy uses the LiMn_{0.5}Ni_{0.5}O₂ composition as a building block to synthesize and stabilize a new family of Mn- and Ni-based lithiated-spinel electrode structures as emphasized in Table 1 in which the normalized and generalized lithiated-spinel notation, LiMnₓNi_{y}M_{z}O₂, is used for convenience to aid the discussion.

In a preferred embodiment, the Mn:Ni ratio in these lithiated-spinel structures is less than 2:1 and greater than 1:2, preferably close to 1:1, and more preferably 1:1, to yield fully-discharged LiMnₓNi_{y}M_{z}O₂ electrodes in which the Mn and Ni ions adopt tetravalent and divalent oxidation states, or oxidation states as close to those ideal values as possible. In another preferred embodiment, M is selected from one or more of Mg, Al and Ga or, alternatively, a combination of Mg and Ti in a 1:1 ratio also referred to herein as 1:1 Mg—Ti). In yet another embodiment; M can be a combination of two or more of Mg, Al, Ga, or 1:1 Mg—Ti.

The lithiated-spinel structures described herein may deviate slightly from their ideal stoichiometric composition by containing cation and/or anion defects or deficiencies, as is known for metal oxide structures. In this case, the sum of x+y+z in LiMnₓNi_{y}M_{z}O₂may deviate slightly from 1 (e.g., up to about 5 mol % deviation), while the oxygen content may deviate slightly from 2 (e.g., up to about 5 mol % deviation). Moreover, it is well known that lithium metal oxides can be synthesized that are either slightly lithium-rich or slightly lithium-deficient, such as found within the Li₁₊ₓMn₂₋ₓO₄ spinel (0<x<0.33) and Li₁₋ₓMn₂O₄ (0<x<1) spinel systems, respectively. Thus, the lithiated spinel LiMnₓNi_{y}M_{z}O₂ electrode materials may deviate from ideal stoichiometry by up to about 5 mol % in the lithium, oxygen or total non-lithium metal content thereof.

In a further embodiment, it is known that F ions can be substituted for the O ions in lithium-metal-oxides, especially near surfaces or within bulk environments, notably Li-rich environments as well as in the presence of oxygen vacancies and local disorder within defect-containing oxides. These F ions can provide, for example, enhanced stability, particularly for Mn-containing compositions, against metal dissolution, surface damage, and reduced cycling and rate performance. Therefore, another aspect of the materials described herein includes LiMnₓNi_{y}M_{z}O_{2-δ}F_{δ} electrode materials in which 0<δ<0.1.

The term “spinel” as used herein in reference to metal oxide materials refers to a material having a spinel-type crystal structure. The prototype “spinel” is the mineral MgAl₂O₄. As explained in Thackeray, J. Am. Ceram. Soc; 1999; 82, 3347-54, spinels have a generic structure A[B₂]X₄ where A refers to cations in the 8a tetrahedral sites and B refers to cations in the 16d octahedral sites of the cubic space group symmetry Fd3̅m (sometimes written as Fd-3m or simply Fd3m in older literature due to the difficulty of typing a macron over the number 3). The X anions, such as oxygen anions, located at the 32e sites form a cubic-close-packed array. Thus, the prototypical spinel can be written in the following form, which identifies the sites of the various cations a within the spinel crystal structure: (A)₈ₐ[B₂]_{16d}O₄ (i.e., X═O) where the square brackets delineate crystallographically independent octahedral sites. There are 64 tetrahedral sites in a typical unit cell, one eighth of which are occupied by the A cations, and 32 octahedral sites, one half of which are occupied by the B cations within the unit cell. Lithium ions can be inserted into a spinel structure to form a product with rock salt stoichiometry, and which has a structure, referred to as a “lithiated spinel”, of formula LiAB₂O₄, alternatively Li[A]_{16c}[B₂]_{16d}O₄, i.e., in which the A cations are displaced from tetrahedral 8a sites of the normal spinel structure to octahedral 16c sites along with the added lithium.

Lithiated-spinel structures with the ideal spinel configuration of atoms also can be represented in spinel notation by the formula Li_{2(16c)}[M_{2(16d)}]O₄₍₃₂ₑ₎, where 16c and 16d refer to all the octahedral sites and 32e to the cubic-close-packed oxygen sites of the crystallographic space group, Fd3̅m. This space group, is also adopted by the prototypic structure of the mineral ‘spinel’, Mg₍₈ₐ₎Al_{2(16d)}O₄₍₃₂ₑ₎, in which the magnesium ions occupy the tetrahedral 8a sites and aluminum the octahedral 16d sites and by the lithium-manganese-oxide spinel structure, Li₍₈ₐ₎Mn_{2(16d)}O₄₍₃₂ₑ₎, in which the lithium ions occupy the tetrahedral 8a sites and manganese ions the octahedral 16d sites. This cubic space group is used herein for convenience to simplify the structural discussion of the lithiated-spinel materials described herein and, particularly, because spinel and lithiated-spinel structures can adopt lower symmetry, as is the case for the spinel, Mn₃O₄, and the lithiated spinel, Li₂[Mn₂]O₄, respectively, both of which have tetragonal symmetry, I4₁/amd. The crystallographic symmetry of the cobalt-free lithiated-spinel structures described herein is therefore not restricted to one space group. It should be noted that lithiated spinels, Li_{2(16c)}[M_{2(16d)}]O₄₍₃₂ₑ₎, can also be regarded as having a rock-salt-type structure because the positively charged Li and M cations occupy all the octahedral sites (16c and 16d) of a cubic-close-packed oxygen lattice. The materials may include ordered and/or partially-disordered lithiated-spinel (rock salt) LiMnₓNi_{y}M_{z}O₂ electrode structures (alternatively Li₂Mn₂ₓNi_{2y}M_{2z}O₄), in which the disorder occurs, for example, between the lithium ions on the octahedral 16c sites and the metal ions on the octahedral 16d sites of a structure with predominant lithiated-spinel character. Such disorder can result in structures with increasing layered character or, alternatively, to structures with a more random distribution of cations in localized regions of the electrode structure, thereby affecting the electrochemical signature and voltage profile of the cell during charge and discharge. Some localized disorder of the lithium and other metal ions between octahedral and tetrahedral sites may also be possible in these electrode structures.

During the electrochemical extraction of lithium during cell charging and reinsertion of lithium during cell discharge in the lithiated-spinel electrodes of described herein, the lithium ions diffuse predominantly through a 3-dimensional intersecting pathway of 8a tetrahedra and 16c octahedra (wherein 8a and 16c refer to crystallographic designations of specific spinel crystal lattice sites). It should, however, be recognized that any disorder of the Li, Mn, Ni or metal (M) ions, as well as the presence of a structurally-integrated layered component in the structure of the electrode material will likely affect these diffusion pathways and the profiles of the electrochemical charge and discharge reactions expected for ordered lithium-metal-oxide spinel electrodes, which are characterized by two-phase (constant voltage) behavior. It can therefore be understood that during electrochemical charge and discharge of the lithiated-spinel electrodes, the lithium-ions, in particular, will be disordered over both tetrahedral and octahedral sites of the structure.

The compositional space, structural features and atomic arrangements of the lithiated- spinel-related materials described herein are broad in scope, the electrochemical properties of which will be dependent on the selection of the metal cations, M, and the location of the electrochemically-active- and electrochemically-inactive metal ions within the ordered- or partially-disordered lithiated-spinel-related structures.

In a further embodiment, these cobalt-free electrode components, can be reacted further, or physically blended, with one or more cobalt-containing lithium-metal-oxide components, such as layered or lithiated-spinel LiCoO₂ or substituted components such as LT-LiCo₁₋ₓAlₓO₂ reported by Lee et al. in ACS Applied Energy Materials, Volume 2, pages 6170-6175 (2019) to form either two-component- or multi-component electrode structurally integrated materials that contain the lithiated-spinel LiMnₓNi_{y}M_{z}O₂materials described herein. Ideally, the cobalt content in these ‘mixed’ electrodes should be as low as possible, preferably close to zero, when it is possible that some Co may be incorporated within the lithiated-spinel structure. A specific embodiment, therefore, includes lithiated-spinel LiMnₓNi_{y}M_{z}O₂ materials in which M can be Co with z at most 0.2 for x+y+z=1, and preferably less than, or equal to z=0.1, or most preferably, less thn or equal to 0.05 to keep the Co content as low as possible.

The electrode materials described herein can include surface treatments and coatings to protect the surface of the electrode particles from undesirable reactions with the electrolyte, for example, by treating or coating the electrode particles with layers of metal-oxide, metal-fluoride or metal-phosphate materials to shield and protect the electrodes from highly oxidizing charging potentials and from other undesirable effects, such as electrolyte oxidation, oxygen loss, and/or dissolution. Such surface protection enhances the surface stability, rate capability and cycling stability of the electrode materials. In some embodiments the lithiated-spinel LiCo₁₋ₓAlₓO₂ (0<x<0.5) materials, described by Lee et al. in ACS Applied Energy Materials, Volume 2, pages 6170-6175 (2019), may be used as protective layers or coatings for the lithiated-spinel LiMnₓNi_{y}M_{z}O₂ electrode materials described herein, particularly when formed by grinding or ball milling the electrode materials with lithiated-spinel LiCo₁₋ₓAlₓO₂ (0<x<0.5) compounds. Conversely, the lithiated-spinel LiMnₓNi_{y}M_{z}O₂ electrode materials described herein can be used as protective coatings for other underlying lithium-metal-oxide electrode materials, such as layered Li—Ni—Mn—O and Li—Mn—Ni—Co—O (NMC) electrode materials and spinel Li—Mn—O (LMO) electrode materials and substituted and compositional variations of these materials.

Non-limiting examples of cobalt-free, lithiated-spinel materials described herein are provided in Table 1, Section (a). Section (b) of Table 1 provides non-limiting examples of compositions comprising at least one cobalt-free lithiated spinel as described herein in combination with (e.g., structurally integrated with, or mixed with) at least one cobalt-containing component.

TABLE 1
Lithiated-spinel LiMnₓNi_{y}M_{z}O₂ electrode compositions (M =
one or more metal cations excluding M = Mn, Ni, Co)

| | | |
|---|---|---|
| Electrode Composition | Molecular | Theoretical Capacity (mAh/g) |
| (net) | Mass (g) | (Amount of Li extracted) |

a) Co-free compositions

| | | | |
|---|---|---|---|
| LiMn_{0.50}Ni_{0.50}O₂ | 95.754 | 280.01 | (1.0 Li) |
| LiMn_{0.45}Ni_{0.45}Al_{0.10}O₂ | 92.771 | 260.11 | (0.9 Li) |
| LiMn_{0.40}Ni_{0.40}Al_{0.20}O₂ | 89.770 | 238.94 | (0.8 Li) |
| LiMn_{0.35}Ni_{0.35}Al_{0.30}O₂ | 83.821 | 191.92 | (0.6 Li) |
| LiMn_{0.4}Ni_{0.4}Ti_{0.1}Mg_{0.1}O₂ | 91.609 | 234.14 | (0.8 Li) |

b) Multi-component compositions comprising one or more lithiated-spinel
LiMnₓNi_{y}M_{z}O₂ component and one or more Co-containing component

| | | | |
|---|---|---|---|
| LiMn_{0.45}Ni_{0.45}Al_{0.05}Co_{0.05}O₂ | 94.369 | 269.91 | (0.95 Li) |
| LiMn_{0.40}Ni_{0.40}Al_{0.10}Co_{0.10}O₂ | 92.983 | 259.52 | (0.90 Li) |
| LiMn_{0.45}Ni_{0.45}Co_{0.10}O₂ | 95.966 | 279.39 | (1.00 Li) |

As used herein the term “lithium battery” refers to electrochemical cells and combinations of electrochemical cells in which lithium (e.g., lithium ion) shuttles between a Si anode and a cathode, and includes so-called full cells, as well as so-called half-cells (e.g. comprising a lithium metal anode).

Electrodes for lithium electrochemical cells typically are formed by coating a slurry of electrode active material in a solvent with a polymeric binder (e.g., poly(vinylidene difluoride); PVDF) onto a current collector (e.g., metal foil, conductive carbon fiber paper, and the like), and drying the coating to form the electrode. Some examples of electrode active materials can be found, e.g., in Mekonnen, Y., Sundararajan, A. & Sarwat, A. I. “A review of cathode and anode materials for lithium-ion batteries,” SoutheastCon 2016, Norfolk, V A., pp. 1-6, (2016) , which is incorporated herein by reference in its entirety.

The electrodes utilize binders (e.g., polymeric binders) to aid in adhering cathode active materials to the current collectors. In some cases, the binder comprises a poly(carboxylic acid) or a salt thereof (e.g., a lithium salt), which can be any poly(carboxylic acid), such as poly(acrylic acid) (PAA), poly(methacrylic acid), alginic acid, carboxymethylcellulose (CMC), poly(aspartic acid) (PAsp), poly(glutamic acid) (PGlu), copolymers comprising poly(acrylic acid) chains, poly(4-vinylbenzoic acid) (PV4BA), and the like, which is soluble in the electrode slurry solvent system. The poly(carboxylic acid) can have a Mₙ, as determined by GPC, in the range of about 1000 to about 450,000 Daltons (preferably about 50,000 to about 450,000 Daltons, e.g., about 130,000 Daltons). In some other embodiments, the binder may comprise anionic materials or neutral materials such as fluorinated polymer such as poly(vinylidene difluoride) (PVDF), carboxymethylcellulose (CMC), and the like.

Lithium-ion electrochemical cells described herein comprise a cathode (positive electrode), an anode (negative electrode), and an ion-conductive separator between the cathode and anode, with the electrolyte in contact with both the anode and cathode, as is well known in the battery art. It is well understood that the function of a given electrode switches from being a positive or negative electrode depending on whether the electrochemical cell is discharging or charging. Nonetheless, for the sake of convenient identification, the terms “cathode” and “anode” as used herein are applied as identifiers for a particular electrode based only on its function during discharge of the electrochemical cell.

Cathodes typically are formed by combining a powdered mixture of the active material and some form of carbon (e.g., carbon black, graphite, or activated carbon) with a binder such as (polyvinylidene difluoride (PVDF), carboxymethylcellulose, and the like) in a solvent (e.g., N-methylpyrrolidone (NMP) or water) and the resulting mixture is coated on a conductive current collector (e.g., aluminum foil) and dried to remove solvent and form an active layer on the current collector.

The anode comprises a material capable of reversibly releasing and accepting lithium during discharging and charging of the electrochemical cell, respectively. Typically, the anode comprises a carbon material such as graphite, graphene, carbon nanotubes, carbon nanofibers, and the like, a silicon-based material such as silicon metal particles, a lead-based material such as metallic lead, a nitride, a silicide, a phosphide, an alloy, an intermetallic compound, a transition metal oxide, and the like. The anode active components typically are mixed with a binder such as (polyvinylidene difluoride (PVDF), carboxymethyl cellulose, and the like) in a solvent (e.g., NMP or water) and the resulting mixture is coated on a conductive current collector (e.g., copper foil) and dried to remove solvent and form an active layer on the current collector.

In some embodiments the anode comprises silicon-containing particles, preferably combined with carbon particles. The silicon-containing particles can be silicon nanoparticles, silicon/silicon oxide (Si/SiOx) nanocomposite particles, silicon nanotubes, microporous silicon, an alloy or intermetallic compound of silicon with a metal such as magnesium, calcium, nickel, iron, or cobalt. Some examples of useful silicon-containing materials are discussed in Ma et al., Nano-Micro Lett., 2014, 6(4):347-358, which is incorporated herein by reference in its entirety. Some other examples are mentioned in Zhu et al., Chemical Science, 2019 10, 7132., which is incorporated herein by reference in its entirety. Si/SiOx nanocomposite particles include e.g., materials described in co-owned, co-pending application Ser. No. 15/663,268 to Wenquan Lu et al., filed on Jul. 28, 2017 which is incorporated herein by reference in its entirety.

Preferably, the silicon-containing particles, when utilized in the anode, have an average size in the range of about 50 to about 200 nm, more preferably about 70 to about 150 nm. The carbon particles can be carbon microparticles or nanoparticles. Non-limiting examples of carbon materials include, e.g., carbon black, graphite, carbon nanotubes, carbon nanofibers, and graphene. Preferably, the electrode includes silicon and carbon particles in a respective weight ratio (Si:C) of about 1:9 to about 9:1, more preferably about 1:5 to about 8:1. The binder typically comprises about 5 to about 30 wt %, preferably about 10 to about 20 wt %, of the active material coated on the current collector, based on the combined weight of the silicon, carbon and binder in the finished electrode (i.e., after drying). The loading of silicon and carbon particles and binder on the current collector typically is in the range of about 0.6 to about 3.2 mg/cm², preferably about 0.8 to about 2.7 mg/cm².

As used herein, the terms “structurally-integrated” and “structurally-integrated composite” when used in relation to a lithium metal oxide a material refers to materials that include domains (e.g., locally ordered, nano-sized or micro-sized domains) indicative of different metal oxide compositions having different crystalline forms (e.g., layered or spinel forms) within a single particle of the composite metal oxide, in which the domains share substantially the same oxygen lattice and differ from each other by the elemental and spatial distribution of metal ions in the overall metal oxide structure. Structurally-integrated composite lithium metal oxides are different from and generally have different properties than mere mixtures or combinations of two or more metal oxide components (for example, mere mixtures do not share a common oxygen lattice).

In electrochemical cell and battery embodiments described herein, the electrolyte comprises an electrolyte salt (e.g., an electrochemically stable lithium salt or a sodium salt) dissolved in a non-aqueous solvent. Any lithium electrolyte salt can be utilized in the electrolyte compositions for lithium electrochemical cells and batteries described herein, such as the salts described in Jow et al. (Eds.), Electrolytes for Lithium and Lithium-ion Batteries; Chapter 1, pp. 1-92; Springer; New York, N.Y. (2014), which is incorporated herein by reference in its entirety.

Non-limiting examples of lithium salts include, e.g., lithium bis(trifluoromethanesulfonyl)imidate (LiTFSI), lithium 2-trifluoromethyl-4,5-dicyanoimidazolate (LiTDI), lithium 4,5-dicyano-1,2,3-triazolate (LiDCTA), lithium trifluoromethanesulfonate (LiTf), lithium perchlorate (LiClO₄), lithium bis(oxalato)borate (LiB(C₂O₄)₂ or “LiBOB”), lithium difluoro(oxalato)borate (LiF₂BC₂O₄ or “LiDFOB”), lithium tetrafluoroborate (LiBF₄), lithium hexafluorophosphate (LiPF₆), lithium hexafluoroarsenate (LiAsF₆), lithium thiocyanate (LiSCN), lithium bis(fluorosulfonyl)imidate (LiFSI), lithium bis(pentafluoroethylsulfonyl)imidate (LiBETI), lithium tetracyanoborate (LiB(CN)₄), lithium nitrate, combinations of two or more thereof, and the like. The lithium salt can be present in the electrolyte solvent at any concentration suitable for lithium battery applications, which concentrations are well known in the secondary battery art. As used herein the term “lithium battery” refers to electrochemical cells and combinations of electrochemical cells in which lithium (e.g., lithium ion) shuttles between an anode and a cathode, and includes so-called full cells with an anode material (e.g., graphite) that can accommodate intercalated lithium ions, as well as so-called half-cells in which the anode is lithium metal. In some embodiments, the lithium salt is present in the electrolyte at a concentration in the range of about 0.1 M to about 5 M, e.g., about 0.5 M to 2 M, or 1 M to 1.5 M. A preferred lithium salt is LiPF₆.

The non-aqueous solvent for the electrolyte compositions include the solvents described in Jow et al. (Eds.), Electrolytes for Lithium and Lithium-ion Batteries; Chapter 2, pp. 93-166; Springer; New York, N.Y. (2014), which is incorporated herein by reference in its entirety. Non-limiting examples of solvents for use in the electrolytes include, e.g., an ether, a carbonate ester (e.g., a dialkyl carbonate or a cyclic alkylene carbonate), a nitrile, a sulfoxide, a sulfone, a fluoro-substituted linear dialkyl carbonate, a fluoro-substituted cyclic alkylene carbonate, a fluoro-substituted sulfolane, and a fluoro-substituted sulfone. For example, the solvent can comprise an ether (e.g., glyme or diglyme), a linear dialkyl carbonate (e.g., dimethyl carbonate (DMC), diethyl carbonate (DEC), ethyl methyl carbonate (EMC) and the like), a cyclic alkylene carbonate (ethylene carbonate (EC), propylene carbonate (PC) and the like), a sulfolane (e.g., sulfolane or an alkyl-substituted sulfolane), a sulfone (e.g., a dialkyl sulfone such as a methyl ethyl sulfone), a fluoro-substituted linear dialkyl carbonate, a fluoro-substituted cyclic alkylene carbonate, a fluoro-substituted sulfolane, and a fluoro-substituted sulfone. The solvent can comprise a single solvent compound or a mixture of two or more solvent compounds.

In some embodiments, the non-aqueous solvent for a lithium electrochemical cell as described herein can be an ionic liquid. Any electrochemically stable ionic liquid solvent can be utilized in the electrolytes described herein, such as the solvents described in Jow et al. (Eds.), Electrolytes for Lithium and Lithium-ion Batteries; Chapter 4, pp. 209-226; Springer; New York, N.Y. (2014), which is incorporated herein by reference in its entirety. In the case of lithium electrochemical cells and batteries, the ionic liquid can optionally include a lithium cation, and can act directly as the electrolyte salt.

The electrolyte compositions for lithium electrochemical cells and batteries described herein also can optionally comprise an additive such as those described in Jow et al. (Eds.), Electrolytes for Lithium and Lithium-ion Batteries; Chapter 3, pp. 167-182; Springer; New York, N.Y. (2014), which is incorporated herein by reference in its entirety. Such additives can provide, e.g., benefits such as SEI, cathode protection, electrolyte salt stabilization, thermal stability, safety enhancement, overpotential protection, corrosion inhibition, and the like. The additive can be present in the electrolyte at any concentration, but in some embodiments is present at a concentration in the range of about 0.0001 M to about 0.5 M. In some embodiments, the additive is present in the electrolyte at a concentration in the range of about 0.001 M to about 0.25 M, or about 0.01 M to about 0.1 M.

Electrochemical cells typically comprise a cathode, an anode typically comprising carbon, silicon, lead, metallic lithium, some other anode active material, or a combination thereof; and a porous separator between the cathode and anode, with the electrolyte in contact with the anode, the cathode and the separator.

A battery can be formed by electrically connecting two or more such electrochemical cells in series, parallel, or a combination of series and parallel. The electrodes described herein preferably are utilized as the anode in a full-cell configuration in lithium-ion and sodium-ion cells and batteries. Electrochemical cells and battery designs and configurations, anode and cathode materials, as well as electrolyte salts, solvents and other battery or electrode components (e.g., separator membranes, current collectors), which can be used in the electrolytes, cells and batteries described herein, are well known in the secondary battery art, e.g., as described in “Lithium Batteries Science and Technology” Gholam-Abbas Nazri and Gianfranco Pistoia, Eds., Springer Science+Business Media, LLC; New York, N.Y. (2009), which is incorporated herein by reference in its entirety.

The separator component of the lithium-ion cell can be any separator used in the lithium battery art. A typical material is a porous polyalkylene material such as microporous polypropylene, microporous polyethylene, a microporous propylene-ethylene copolymer, or a combination thereof, e.g., a separator with layers of different polyalkylenes; a poly(vinylidene-difluoride)-polyacrylonitrile graft copolymer microporous separator; and the like. Examples of suitable separators are described in Arora et al., Chem. Rev. 2004, 104, 4419-4462, which is incorporated herein by reference in its entirety. In addition, the separator can be an ion-selective ceramic membrane such as those described in Nestler et al., AIP Conference Proceedings 1597, 155 (2014), which is incorporated herein by reference in its entirety.

Processes used for manufacturing lithium cells and batteries are well known in the art. The active electrode materials are coated on both sides of metal foil current collectors (typically copper for the anode and aluminum for the cathode) with suitable binders such as PVDF and the like to aid in adhering the active materials to the current collectors. In the cells and batteries described herein, the active cathodes are the lithiated-spinel materials, LiMnₓNi_{y}M_{z}O₂, defined herein, which optionally can be utilized with a carbon material such as graphite, and the anode active material typically is a lithium metal, carbon, and the like. Cell assembly typically is carried out on automated equipment. The first stage in the assembly process is to sandwich a separator between the anode and the cathode. The cells can be constructed in a stacked structure for use in prismatic cells, or a spiral wound structure for use in cylindrical cells. The electrodes are connected to terminals and the resulting sub-assembly is inserted into a casing, which is then sealed, leaving an opening for filling the electrolyte into the cell. Next, the cell is filled with the electrolyte and sealed under moisture-free conditions.

Once the cell assembly is completed, the cell typically is subjected to at least one controlled charge/discharge cycle to activate the electrode materials and in some cases form a solid electrolyte interface (SEI) layer on the anode. This is known as formation cycling. The formation cycling process is well known in the battery art and involves initially charging with a low voltage (e.g., substantially lower that the full-cell voltage) and gradually building up the voltage. The SEI acts as a passivating layer which is essential for moderating the charging process under normal use. The formation cycling can be carried out, for example, according to the procedure described in Long et al. J. Electrochem. Soc., 2016; 163 (14): A2999-A3009, which is incorporated herein by reference in its entirety. This procedure involves a 1.5 V tap charge for 15 minutes at C/3 current limit, followed by a 6-hour rest period, and then 4 cycles at C/10 current limit, with a current cutoff (i≤0.05 C) at the top of each charge.

Cathodes comprising the cobalt free lithiated spinel materials described herein can be utilized with any combination of anode and electrolyte in any type of rechargeable battery system that utilizes a non-aqueous electrolyte.

The following general methodology and non-limiting Examples are provided to illustrate certain features of the compositions and methods described herein.

METHODOLOGY 1. Synthesis of LiMnₓNi_{y}M_{z}O₂(M=Al) Materials.

A parent, unsubstituted LiMn_{0.5}Ni_{0.5}O₂ electrode material (x=0.5; y=0) is prepared by a ‘low-temperature’ method reported previously by Gummow et al. in Mat. Res. Bull. 27, 327 (1992), and U.S. Pat. No. 5,160,712. Cation substituted materials of formula LiMnₓNi_{y}Al_{z}O₂, for x=0.45, 0.35, 0.30; y=0.45, 0.35, 0,30; and z=0.1, 0.2, 0.3, respectively, as listed in Table 1, are prepared by solid-state reaction of lithium carbonate (Li₂CO₃, >99%), manganese hydroxide, nickel hydroxide and aluminum nitrate (Al(NO₃)₃.9H₂O, >99%) precursors. Alternatively, mixed-metal precursors, such as manganese-nickel hydroxide, or metal oxide precursors, such as manganese dioxide, can be used. Stoichiometric amounts of the precursors are thoroughly mixed using a mortar and pestle, and fired in air at 400° C. in a furnace for approximately 6 days. The heating rate is about 2° C. per min. The samples are cooled in the furnace without controlling the cooling rate. Samples can also be prepared in air at higher temperature, i.e., at 450, 500, 550 and 600° C. to increase the layered character of the LiMn_{0.5}Ni_{0.5}O₂ and LiMn,Ni_{y}Al_{z}O₂ electrode structures.

It should be noted that for materials in which the Mn:Ni ratio is 1:1, and in which the manganese and nickel ions are tetravalent and divalent, respectively, for example LiMn_{0.45}Ni_{0.45}Al_{0.10}O₂, the full electrochemical capacity of the electrode (260 mAh/g, Table 1) would, in principle, be associated with the oxidation of Ni²⁺ to Ni⁴⁺ and the extraction of 0.9 Li⁺ ions from an electrode structure in which only 45% of the non-lithium metal ions (Mn, Ni, Al) is nickel. It is anticipated that such an electrode composition would have significant cost and safety advantages over their nickel-rich NMC counterparts, for example, LiNi_{0.8}Mn_{0.1}Co_{0.1}O₂ (‘811’) and LiNi_{0.6}Mn_{0.2}Co_{0.2}O₂ (‘622’) in lithium-ion cells. In addition, nearest neighbor Mn—Ni interactions may assist electronic conductivity of these lithiated-spinel-related electrodes during electrochemical operation.

METHODOLOGY 2. Synthesis of Two-Component Materials Comprising a LiMnₓNi_{y}Al_{z}O₂ Component and a Cobalt-Containing Lithium-Metal-Oxide Component.

The materials of Example 1 are combined with a LT-LiCoO₂ lithiated-spinel product that is prepared at 400° C. as described by Lee et al. in ACS Applied Energy Materials, Volume 2, pages 6170-6175 (2019), either by mechanical blending, for example, by high-energy ball milling at room temperature, or by reaction in air at temperatures between 400 and 600° C. to yield composite electrode structures with two or more lithium-metal-oxide components that can be integrated structures or blended mixtures having either lithiated-spinel character or a combination of lithiated-spinel and layered character, and disordered structural variations thereof.

### METHODOLOGY 3. Electrochemical Evaluations.

Coin-type cells (2032, Hohsen) are constructed in an argon-filled glovebox 5 ppm O₂ and H₂O). The cathode consists of approximately 84 percent by weight (wt %) of LiMnₓNi_{y}M_{z}O₂ powder (M=Al), 8 wt % carbon, and 8 wt % PVDF binder on aluminum foil. The anode is metallic lithium foil or an alternative host electrode for lithium, such as graphite or Li₄Ti₅O₁₂. The electrolyte is typically 1.2 M LiPF₆ in a 3:7 (w/w) mixture of ethylene carbonate and ethyl-methyl carbonate. For the cycling experiments, Li/LiMnₓNi_{y}M_{z}O₂ cells (M=Al) are galvanostatically charged and discharged between 2.5 and 4.2 V at a current rate of either approximately 15 mA/g or approximately 60 mA/g. The electrochemical experiments are conducted at approximately 30° C.

### EXAMPLE 1

### LT-LiMn_{0.5}Ni_{0.5}O₂

LT-LiMn_{0.5}Ni_{0.5}O₂ was prepared as follows:

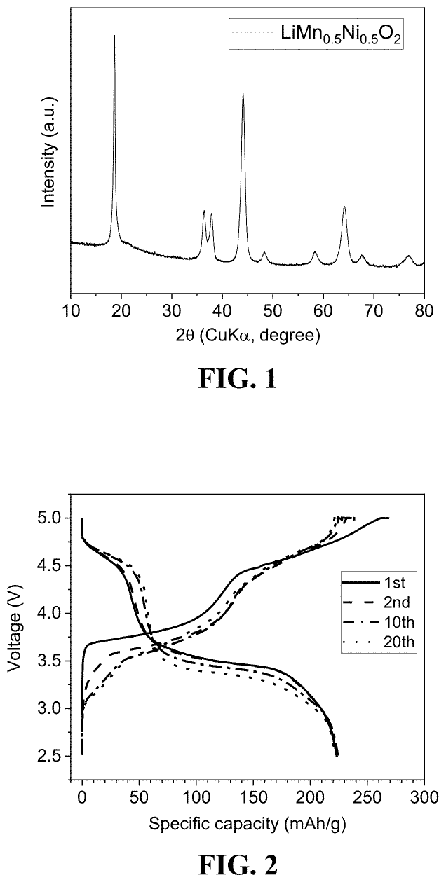

A Mn_{0.5}Ni_{0.5}(OH)₂ precursor was first prepared by a co-precipitation reaction in an aqueous solution containing manganese sulfate (MnSO₄) and nickel sulfate (NiSO₄). A LT-LiMn_{0.5}Ni_{0.5}O₂ electrode material was synthesized by a ‘low-temperature’ solid-state reaction of the Mn_{0.5}Ni_{0.5}(OH)₂ precursor and lithium carbonate (Li₂CO₃, >99%). Stoichiometric amounts of the precursors were thoroughly mixed using a mortar and pestle, and fired in air at 400° C. for approximately 72 hours. The heating rate was about 2° C. per min, and the samples were cooled in the furnace without controlling the cooling rate. The X-ray diffraction (XRD) pattern of LT-LiMn_{0.5}Ni_{0.5}O₂ is shown in FIG. 1.

Li/LT-LiMn_{0.5}Ni_{0.5}O₂ cells were assembled and evaluated as follows: Coin-type cells (2032, Hohsen) were assembled in an argon-filled glovebox (<5 ppm O₂ and H₂O) for electrochemical tests. The cathode electrode consisted of approximately 84 wt % of LT-LiMn_{0.5}Ni_{0.5}O₂ powder, 8 wt % carbon, and 8 wt % polyvinylidene difluoride (PVDF) binder on an aluminum foil current collector. The anode was metallic lithium foil. The electrolyte was 1.2 M lithium hexafluorophosphate (LiPF₆) in a 3:7 mixture of ethylene carbonate and ethyl methyl carbonate. The coin cell was galvanostatically charged and discharged between 2.5 and 5.0 V at a constant current of approximately 15 mA/g. Electrochemical experiments were conducted at about 30° C. Voltage (V) vs. specific capacity (mAh/g) plots of a Li/LT-LiMn_{0.5}Ni_{0.5}O₂ cell cycled between 5.0 and 2.5 V for the first 20 cycles are shown in FIG. 2.

### EXAMPLE 2

### LT-LiMn_{0.5}Ni_{0.5}O₂

LT-LiMn_{0.5}Ni_{0.5}O₂ was prepared as described in Example 1.

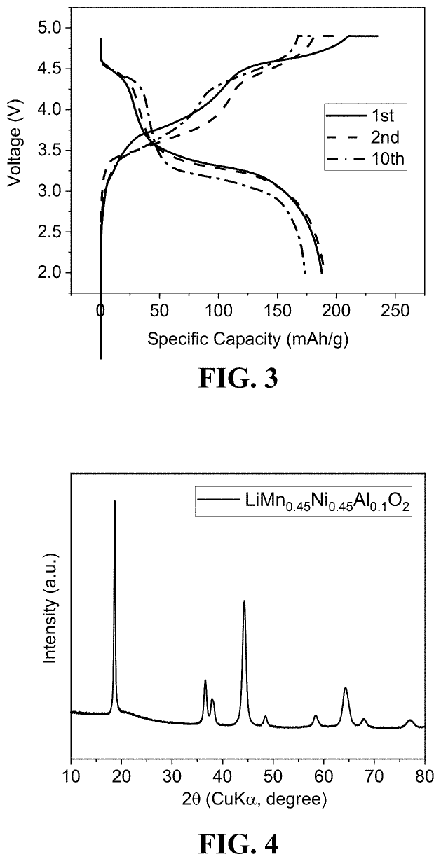

Graphite/LT-LiMn_{0.5}Ni_{0.5}O₂ cells were assembled following a similar procedure as described in Example 1, except that a graphite anode was used instead of metallic Li, and evaluated as follows: Anode laminates were prepared by coating a graphite slurry on copper foil. The composition of the graphite slurry was 91.83 wt % graphite powder, 2 wt % carbon black, 6 wt % PVDF binder, and 0.17% oxalic acid. Coin cells were cycled between 2.0 to 4.9 Vat a constant current of 100 mA/g. Voltage (V) vs. specific capacity (mAh/g) plots of a graphite/LT-LiMn_{0.5}Ni_{0.5}O₂ cell cycled between 4.9 and 2.0 V for the first 10 cycles are shown in FIG. 3.

### EXAMPLE 3

### LT-LiMn_{0.45}Ni_{0.45}Al_{0.1}O₂

LT-LiMn_{0.45}Ni_{0.45}Al_{0.1}O₂ was prepared as follows: The LT-LiMn_{0.45}Ni_{0.45}Al_{0.1}O₂ powder was prepared following a similar procedure described in Example 1. Stoichiometric amounts of Li₂CO₃, Mn_{0.5}Ni_{0.5}(OH)₂, and aluminum nitrate nonahydrate (Al(NO₃)₃.9H₂O, >98%) precursors were thoroughly mixed with a planetary ball mill (RESTCH PM 200). The mixed powder was pressed into a pellet and fired in air at 400° C. for approximately 72 hours. The XRD diffraction pattern of the LT-LiMn_{0.45}Ni_{0.45}Al_{0.1}O₂ product is shown in FIG. 4.

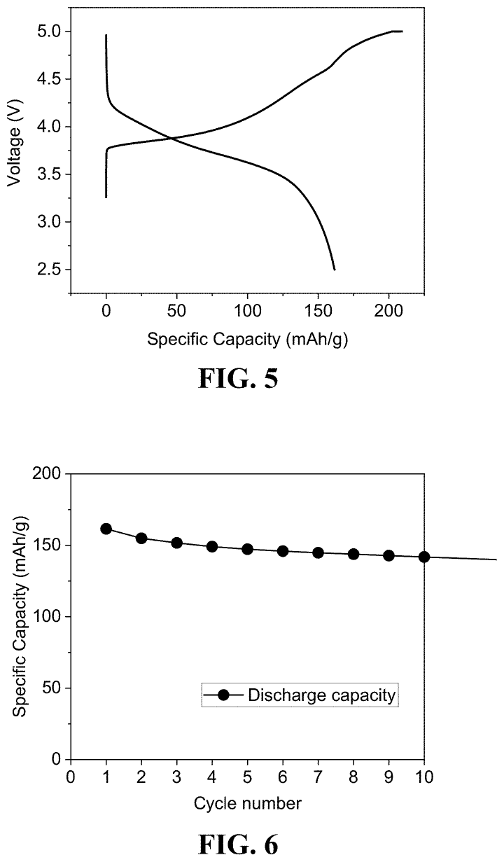

Li/LT-LiMn_{0.45}Ni_{0.45}Al_{0.1}O₂ cells with a metallic Li anode were assembled and evaluated as described in Example 1. The initial voltage (V) vs. specific capacity (mAh/g) plot of a Li/LT-LiMn_{0.45}Ni_{0.45}Al_{0.1}O₂ cell cycled between 5.0 and 2.5 V is shown in FIG. 5. Specific capacity vs. cycle number plots for this cell, cycled between 5.0 and 2.5 V for the first 10 cycles, are shown in FIG. 6.

Of particular note is that the voltage profile of the cell in which Al is used as a minor substituent in the LT-LiMn_{0.45}Ni_{0.45}Al_{0.1}O₂ electrode (FIG. 5) does not show the pronounced two-step process during charge and discharge, similar to that observed in cells containing the parent lithiated-spinel electrode LT-LiMn_{0.5}Ni_{0.5}O₂ (FIG. 2). However, this feature is similar to that observed in a Mg-substituted electrode, LT-LiMn_{0.45}Ni_{0.45}Mg_{0.1}O₂, and also in a reference Al-substituted LT-LiCo₁₋ₓAlₓO₂ electrode, which is attributed to some disorder of Al between the octahedral 16c sites and the octahedral 16c sites of a lithiated-spinel structure with space group symmetry Fd3̅m, as described by Lee et al. in ACS Applied Energy Materials, Volume 2, pages 6170-6175 (2019).

### EXAMPLE 4

### Physical Blend: LT-LiMn_{0.5}Ni_{0.5}O₂ (90%)+LT-LiCo_{0.75}Al_{0.25}O₂ (Li Anode Cell)

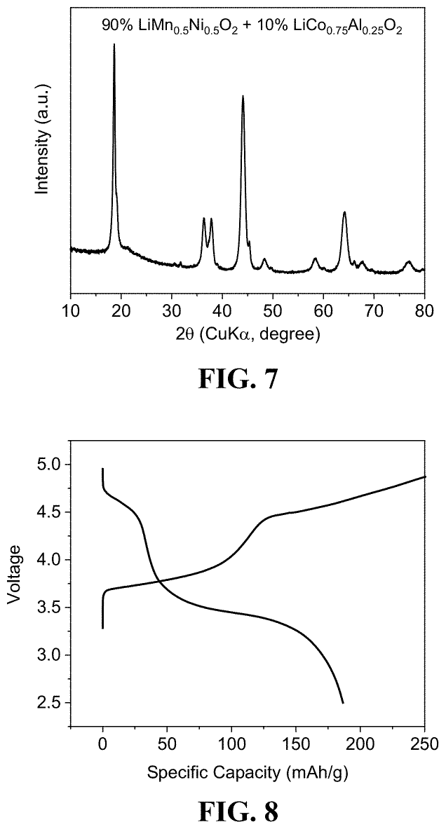

LT-LiMn_{0.5}Ni_{0.5}O₂ was prepared by the method described in Example 1. LT-LiCo_{0.75}Al_{0.25}O₂ was prepared as follows: Stoichiometric amounts of Li₂CO₃, CoCO₃, and Al(NO₃)_{3.9}H₂O were thoroughly mixed using a mortar and pestle. The mixture was then fired in air at 400° C. for 6 days. A blended electrode material was prepared by mechanically grinding the LT-LiMn_{0.5}Ni_{0.5}O₂ and LT-LiCo_{0.75}Al_{0.25}O₂ powders in a 90:10 percent ratio by mass using a mortar and pestle. The X-ray diffraction pattern of a LT-LiMn_{0.5}Ni_{0.5}O₂+LT-LiCo_{0.75}Al_{0.25}O₂ electrode powder, blended in a 90:10 percent ratio by mass, respectively, is shown in FIG. 7.

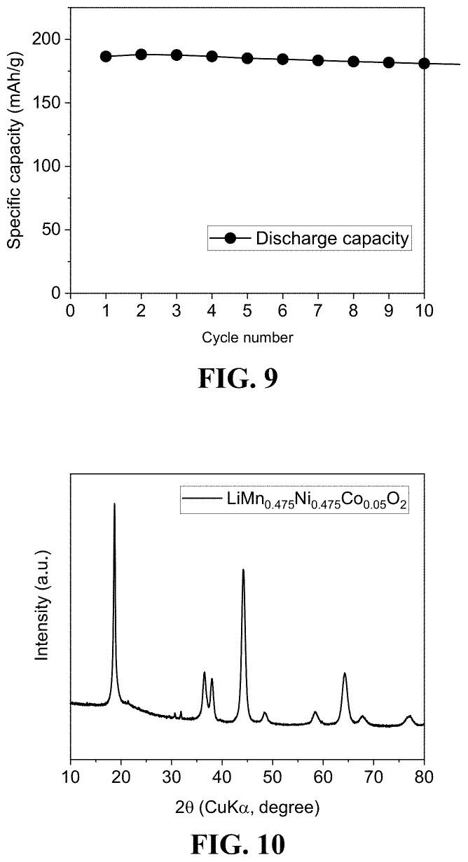

Li/LT-LiMn_{0.45}Ni_{0.45}Al_{0.1}O₂ cells with a metallic Li anode were assembled and evaluated as described in Example 1. The electrochemical profile of the initial charge and discharge of a Li/LT-LiMn_{0.5}Ni_{0.5}O₂+LT-LiCo_{0.75}Al_{0.25}O₂ cell when activated to 5.0 V and discharged to 2.5 V as a function of voltage (V) and specific capacity (mAh/g) is shown in FIG. 8. Corresponding specific capacity vs. cycle number plots of this Li/LT-LiMn_{0.5}Ni_{0.5}O₂+LT-LiCo_{0.75}Al_{0.25}O₂ cell cycled between 5.0 and 2.5 V for the first 10 cycles is shown in FIG. 9.

### EXAMPLE 5

### LT-LiMn_{0.475}Ni_{0.475}Co_{0.05}O₂

LT-LiMn_{0.475}Ni_{0.475}Co_{0.05}O₂ powder was prepared following a similar procedure to that described in Example 1. Stoichiometric amounts of Li₂CO₃ and Mn_{0.475}Ni_{0.475}Co_{0.05}(OH)₂ precursors were thoroughly mixed using a mortar and pestle and fired in air at 400° C. for approximately 72 hours. The XRD diffraction pattern of LT-LiMn_{0.475}Ni_{0.475}Co_{0.0}5O₂ is shown in FIG. 10.

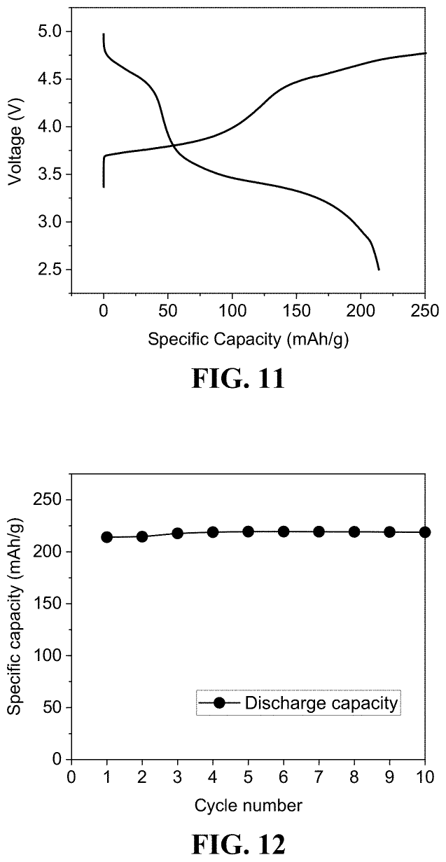

LT-LiMn_{0.475}Ni_{0.475}Co_{0.05}O₂ cells were assembled and evaluated as in Example 1. The electrochemical profile of the initial charge and discharge of a LULT-LiMn_{0.475}Ni_{0.475}Co_{0.05}O₂ cell when activated to 5 V and discharged to 2.5 V as a function of voltage (V) and specific capacity (mAh/g) is shown in FIG. 11. Corresponding voltage (V) vs. specific capacity (mAh/g) plots of this cell, when cycled between 5.0 and 2.5 V for the first 10 cycles is shown in FIG. 12.

In the above examples, the upper cut-off voltage was 5.0 V for the cells with a Li anode, and 4.9 V for the cell with a graphite anode. This high voltage was selected to maximize capacity and assess the stability of the electrode materials. In practice, it is anticipated that greater cycling stability of the cells will be achieved by lowering the upper cut-off voltage, for example to 4.75 V or lower, albeit with lower capacity. In this respect, improvements in the electrochemical properties of the electrode materials described herein can be expected by tailoring their synthesis and the voltage window of the cells during electrochemical cycling to achieve optimum cell performance.

### Electrochemical Cells and Batteries

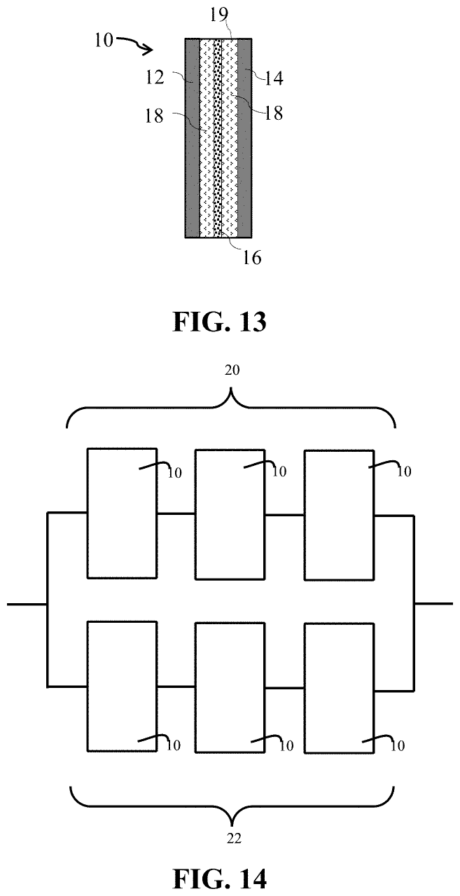

FIG. 13 schematically illustrates a cross-sectional view of a lithium-ion electrochemical cell 10 comprising first electrode 12 comprising a lithiated spinel electrode active material as described herein, and a second electrode 14, with separator 16 therebetween. A lithium- containing electrolyte 18 comprising a solution of a lithium salt in a non-aqueous solvent contacts electrodes 12 and 14 and separator 16. The electrodes, separator and electrolyte are sealed within housing 19. FIG. 14 schematically illustrates a lithium-ion battery comprising a first array 20 consisting of three series-connected electrochemical cells 10, and a second array 22 consisting of three series-connected electrochemical cells 10, in which first array 20 is electrically connected to second array 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. A cobalt-free electrode active material for a lithium electrochemical cell with a lithiated spinel structure having the empirical formula LiMnₓNi_{y}M_{z}O₂; wherein M comprises one or more metal cations other than manganese, nickel and cobalt; x+y+z=1; 0<x<1.0; 0<y<1.0; 0≤z≤0.5; and having a molar Mn:Ni ratio in the range of about 1:2 to about 2:1.

2. The electrode active material of claim 1, wherein the Mn:Ni ratio is about or equal to 1:1.

3. The electrode active material of claim 1, wherein M comprises one or more metal cation selected from the group consisting of an Al cation, a Ga cation, a Mg cation and a combination of Mg and Ti cations.

4. The electrode active material of claim 1, wherein at least two of the Li, Mn, Ni and M cations in the lithiated spinel are partially disordered over the octahedral sites of the lithiated-spinel structure.

5. The electrode active material of claim 1, wherein the lithiated-spinel structure contains cation and/or anion defects or deficiencies.

6. The electrode active material of claim 1, wherein the lithium, oxygen, and/or total non-lithium metal content of the lithiated-spinel composition LiMnₓNi_{y}M_{z}O₂ varies by up to about 5 percent from an ideal 1:1:2 respective elemental stoichiometry.

7. The electrode active material of claim 1, further comprising fluorine in place of a portion of the oxygen in the LiMnₓNi_{y}M_{z}O₂; wherein less than 10 mole percent of the oxygen is replaced by fluorine.

8. An electrode active composition for an electrochemical cell comprising a first lithium-free electrode active material with a lithiated spinel structure mechanically blended with or structurally integrated with or a second electrode active material; wherein the first electrode active material has the empirical formula LiMnₓNi_{y}M_{z}O₂; wherein M comprises one or more metal cations other than manganese, nickel and cobalt; x+y+z=1; 0<x<1.0; 0<y<1.0; 0≤z≤0.5; and having a molar Mn:Ni ratio in the range of about 1:2 to about 2:1; and the second electrode active material comprises one or more cobalt-containing lithium metal oxide material.

9. The electrode active composition of claim 8, wherein the cobalt-containing lithium metal oxide material comprises LiCoO₂ with a layered-type structure and/or LiCoO₂ with a lithiated-spinel-type structure.

10. The electrode active composition of claim 8, wherein Co comprises less than about 33 mol % of non-lithium metal ions in the electrode active material.

11. The electrode active composition of claim 8, wherein Co comprises less than 20 mol % of non-lithium metal ions in the electrode active material.

12. The electrode active composition of claim 8, wherein Co comprises less than 10 mol % of the non-lithium metal ions.

13. An electrode for a lithium electrochemical cell comprising particles of the electrode active material of claim 1 in a binder matrix coated on a metal or carbon current collector.

14. An electrode for a lithium electrochemical cell comprising particles of the electrode active material of claim 6 in a binder matrix coated on a metal or carbon current collector.

15. An electrochemical cell comprising an anode, a cathode, and a lithium-containing electrolyte contacting the anode and cathode, wherein the cathode comprises the electrode of claim 14.

16. A battery comprising a plurality of electrochemical cells of claim 15 electrically connected in series, in parallel, or in both series and parallel.

17. An electrochemical cell comprising an anode, a cathode, and a lithium-containing electrolyte contacting the anode and cathode, wherein the cathode comprises the electrode of claim 14.

18. A battery comprising a plurality of electrochemical cells of claim 17 electrically connected in series, in parallel, or in both series and parallel.

19. A method for preparing the electrode active material of claim 1, comprising heating a mixture of precursor salts at a temperature in the range of about 200 to about 600° C. in an oxygen-containing atmosphere; wherein the precursor salts comprises salts of Li, Mn, Ni and M cations with anions selected from the group consisting of carbonate, hydroxide, oxide, and nitrate; and the Li, Mn, Ni and M salts are present in a stoichiometric ratio selected to provide a target lithiated spinel of formula LiMnₓNi_{y}M_{z}O₂; wherein M comprises one or more metal cations other than manganese, nickel and cobalt; x+y+z=1; 0<x<1.0; 0<y<1.0; 0≤z≤0.5; and having a molar Mn:Ni ratio in the range of about 1:2 to about 2:1.

20. The method of claim 19, wherein the mixture of precursor salts is heated at a temperature in the range of about 400 to 600° C.

21. The method of claim 19, wherein the lithium salt is lithium carbonate, and the Ni, Mn, M salts are single or mixed metal hydroxides of Ni, Mn, and M metal cations.

22. An electrode active material for a lithium electrochemical cell with a lithiated spinel structure having the empirical formula LiMnₓNi_{y}M_{z}O₂; wherein M comprises Co and, optionally, other metals besides manganese and nickel; x+y+z=1; 0<x<1.0; 0<y<1.0; 0≤z≤0.2; and having a molar Mn:Ni ratio in the range of about 1:2 to about 2:1.

23. The electrode active material of claim 22, in which 0≤z≤0.1.

24. A method for preparing the electrode active material of claim 22, comprising heating a mixture of precursor salts at a temperature in the range of about 200 to about 600° C. in an oxygen-containing atmosphere; wherein the precursor salts comprises salts of Li, Mn, Ni and M cations with anions selected from the group consisting of carbonate, hydroxide and nitrate, and the Li, Mn, Ni and M salts are present in a stoichiometric ratio selected to provide a target lithiated spinel of formula LiMnₓNi_{y}M_{z}O₂; wherein M comprises Co and, optionally, other metal cations besides manganese and nickel; x+y+z=1; 0<x<1.0; 0<y<1.0; 0≤z≤0.2; and having a molar Mn:Ni ratio in the range of about 1:2 to about 2:1.

25. An electrode active material comprising the electrode active material of claim 1 coated with a metal-oxide, a metal fluoride or a metal phosphate layer.

26. The electrode active material of claim 25, wherein the metal oxide layer is a lithiated-spinel LiCo₁₋ₓAlₓO₂.

27. An electrode active material comprising the electrode active material of claim 1 as a protective surface coating on an underlying lithium-metal-oxide electrode material.

28. The lithium-metal-oxide electrode material of claim 27, wherein the underlying lithium-metal-oxide material has a layered or spinel structure.
